(19) United States
(12) Patent Application Publication
(10) Pub. No.: US 2011/0249541 A1
(43) Pub. Date: Oct. 13, 2011

(54) OPTICAL DISC UNIT AND SERVO CONTROL METHOD FOR ACTUATOR THEREOF

(76) Inventor: Akihiro ASHIDA, Yashio (JP)

(21) Appl. No.: 13/080,689

(22) Filed: Apr. 6, 2011

(30) Foreign Application Priority Data
Apr. 7, 2010 (JP) JP2010-088607

(51) Int. Cl. G11B 7/09

(52) U.S. Cl. 369/44.35; 369/44.11; G9B/7.062

(57) ABSTRACT

In servo control of actuators of an optical disc unit, a gain margin is secured by measuring a mean current or mean voltage applied to each of a focus actuator and a tracking actuator, estimating a displacement quantity of each of the actuators from the measurement values, changing the frequency characteristic or overall servo loop characteristic of a focus servo filter and a tracking servo filter respectively by switching ON/OFF a notch filter according to a displacement condition of the corresponding actuator, and switching control operation between stages of servo control characteristic of each of the focus servo filter and tracking servo filter.

The optical disc unit can achieve a stable servo control of the actuators thereof without performing disturbance injection or taking measurement of the disturbance. Thus, the optical disc unit can ensure stable operations.

### CLAIMS OF PRIORITY

The present application claims priority from Japanese patent application serial no. JP2010-088607, filed on Apr. 7, 2010, the content of which is hereby incorporated by reference into this application.

### BACKGROUND OF THE INVENTION

The present invention relates to an optical disc unit and a servo control method for actuator thereof. More particularly, the invention relates to an optical disc unit featuring highly stable servo control of the actuator thereof and a servo control method therefor.

Recently, the optical disc units tend to be complicated in the structure of an optical pickup in order to comply with a new standard such as the Blu-ray disc standard. The complicated structure design may sometimes entail a problem that some part has a lower structural strength than that of the conventional design. This leads to a negative effect that an unwanted resonance point appears in the frequency characteristics of focus actuator and tracking actuator for moving an objective lens. Further, the resonance characteristic is also complicated as the resonance characteristic is varied in according to the position of the actuator (in focus direction, tracking direction and the like).

A band eliminate filter such as a notch filter is commonly used to prevent servo stability from being affected by the characteristic of resonance occurring in the actuator. JP-A No. H9-120550, for example, discloses a technique for optimizing the frequency characteristic of the notch filter by varying the Q value thereof according to the environmental change such as temperature. Servo control employed by this technique is a system wherein a magnitude of resonance is measured by injecting disturbance at the same frequency as a resonance frequency into a servo loop, the disturbance serving as an index of Q-value variation.

According to the prior-art technique disclosed in the above JP-A No. H9-120550, loop characterization based on disturbance injection is necessary and hence, it is practically difficult to implement the servo control when an optical disc drive is performing a reading or writing operation. This leads to a problem that the servo control is not applicable to a case where the characteristics of the actuator vary according to the operation conditions thereof (e.g., variation of focus height due to disc warpage, lens displacement in the tracking direction and the like).

The present invention addresses the above-described problem and seeks to provide an optical disc unit that can ensure stable operations by achieving stable servo control of the actuator thereof without performing the disturbance injection or taking measurement of the disturbance.

### SUMMARY OF THE INVENTION

According to the present invention, a mean current or mean voltage applied to each of the focus actuator and the tracking actuator of the pickup is measured in order to cope with the variation of resonance frequency characteristic, in particular, induced by the displacement of each of the focus actuator and tracking actuator. A displacement quantity of each of the actuators is estimated from the measurement values. The frequency characteristic or overall servo loop characteristic of a focus servo filter and a tracking servo filter is changed respectively by switching ON/OFF the notch filter according to the displacement condition of the corresponding actuator. A stability margin of the servo control (e.g., gain margin and phase margin) is secured by switching control operation between stages of the servo control characteristic of each of the focus servo filter and the tracking servo filter thereby achieving stable servo control of the focus actuator and the tracking actuator.

### BRIEF DESCRIPTION OF THE DRAWINGS

FIG. 1 is a block diagram showing a system configuration of an optical disc unit according to one embodiment of the invention;

FIG. 2 is a block diagram for illustrating a servo control operation of the optical disc unit according to the one embodiment of the invention;

FIG. 3 is a number line graph showing a relation between each mean measurement value and response;

FIG. 4 is a graph showing gain characteristic curves of a notch filter A and a notch filter B;

FIG. 5A is a Bode diagram plotting the resonance characteristic variations of a focus actuator displaced in a focus direction (part 1);

FIG. 5B is a Bode diagram plotting the resonance characteristic variations of the focus actuator displaced in the focus direction (part 2);

FIG. 5C is a Bode diagram plotting the resonance characteristic variations of the focus actuator displaced in the focus direction (part 3);

FIG. 6A is a Bode diagram representing an open-loop frequency characteristic in a control stage (part 1);

FIG. 6B is a Bode diagram representing an open-loop frequency characteristic in another control stage (part 2);

FIG. 6C is a Bode diagram representing an open-loop frequency characteristic in another control stage (part 3);

FIG. 6D is a Bode diagram representing an open-loop frequency characteristic in another control stage (part 4); and

FIG. 6E is a Bode diagram representing an open-loop frequency characteristic in another control stage (part 5).

### DESCRIPTION OF THE PREFERRED EMBODIMENT

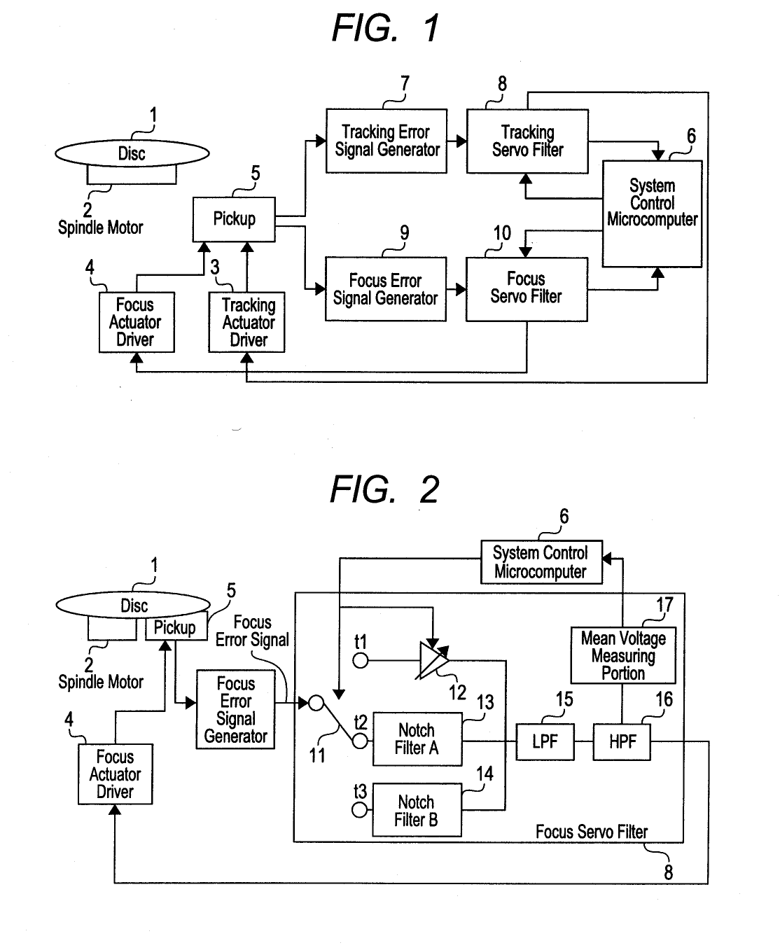

One embodiment of the present invention will be described as below with reference to FIG. 1 to FIG. 6E.

Referring to FIG. 1, description is first made on a system configuration of an optical disc unit according to the one embodiment of the invention.

FIG. 1 is a block diagram showing the system configuration of the optical disc unit according to the one embodiment of the invention.

Of the optical disc unit, a mechanism for rotating an optical disc 1 (CD, DVD, BD or the like) and a mechanism responsible for servo control are shown in FIG. 1.

The optical disc 1 is rotated by a spindle motor 2. A pickup 5 emits a laser beam from a laser diode (not shown) onto the optical disc 1 so as to write information thereon or to read written information therefrom. At this time, actuators move a lens holder (not shown) in respective directions in order to apply a suitable output laser beam to a suitable position. A focus actuator driver 4 moves a focus actuator (not shown) in a focus (vertical) direction while a tracking actuator driver 3 moves a tracking actuator (not shown) in a tracking (horizontal) direction.

In response to the operation of the focus actuator, a focus error signal generator 9 generates a focus error signal and inputs the signal to a focus servo filter 10 as servo information.

The focus servo filter 10 in turn outputs to the focus actuator driver 4 a piece of servo information suitable for providing the servo control.

In response to the operation of the tracking actuator, a tracking error signal generator 7 similarly generates a tracking error signal and inputs the signal to a tracking servo filter 8 as the servo information.

The tracking servo filter 8 in turn outputs to the tracking actuator driver 3 a piece of servo information suitable for providing the servo control.

Next, a servo control operation of the optical disc unit according to the one embodiment of the invention is described with reference to FIG. 2.

FIG. 2 is a block diagram for illustrating the servo control operation of the optical disc unit according to the one embodiment of the invention.

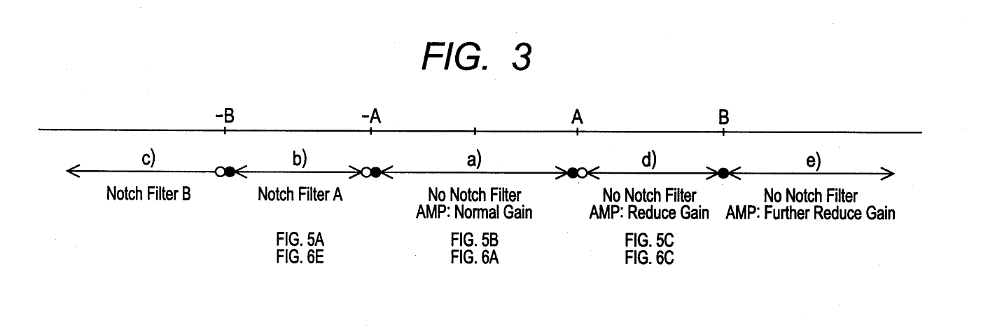

FIG. 3 is a number line graph showing a relation between each mean measurement value and response.

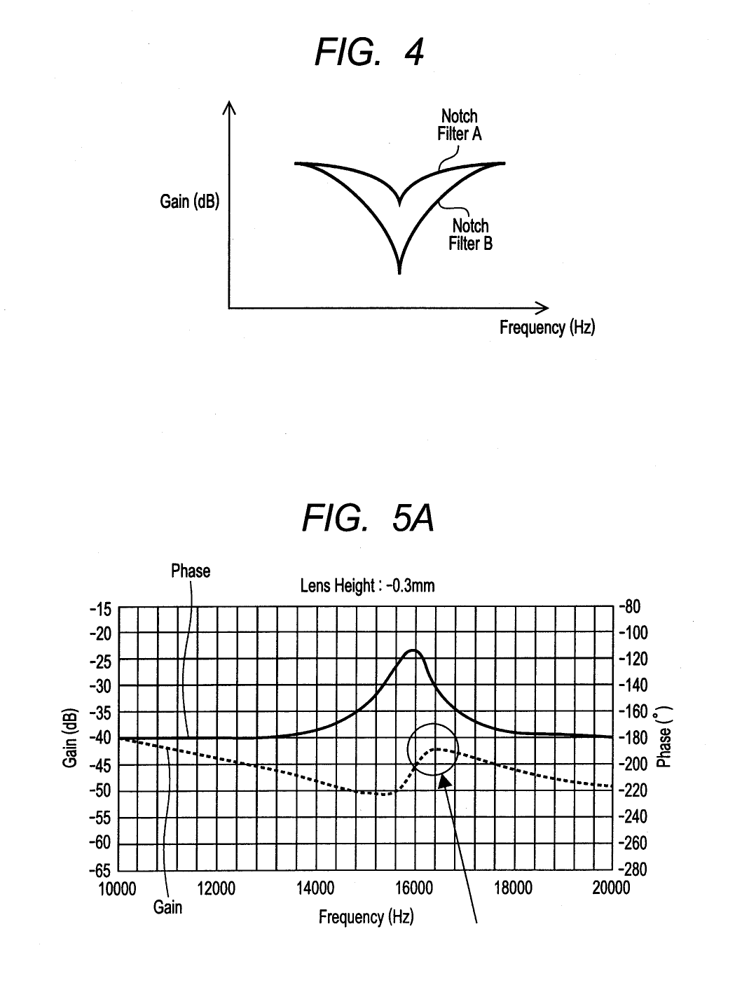

FIG. 4 is a graph showing gain characteristic curves of a notch filter A and a notch filter B.

While the embodiment illustrates the servo operation in the focus direction, the servo operation in the tracking direction is based on the same theory of operation. The term “focus” in the following description may be replaced by the term “tracking” to give the explanation of the servo operation in the tracking direction.

Particularly, the invention is adapted to cope with the variation of frequency characteristic of the filter which is induced by the displacement of the actuator. Specifically, a mean current or mean voltage applied to the focus actuator or the tracking actuator is measured and a displacement quantity of the actuator is estimated from the measurement values. This is because the mean current and mean voltage is in direct proportion to the displacement quantity of the actuator. When the displacement quantity increases, the characteristic related to servo control, such as the frequency characteristic or the gain of the overall servo loop characteristic, is changed by switching ON/OFF the notch filter.

Specifically, as the focus actuator or the tracking actuator is increased in the quantity of displacement from normal position, the characteristic of induced actuator resonance varies so that the stability margin of the servo control is decreased, resulting in instable servo control. This is because the increased quantity of displacement may entail the degradation of magnetic characteristic of the actuator or the displacement of centroid position of the actuator due to the mechanical structure thereof.

In the embodiment, therefore, servo characteristic correction for increasing the gain margin is performed when the actuator is displaced in large quantity.

The focus error signal generator 9 of the embodiment generates a focus error signal and inputs the signal to the focus servo filter 10 as the servo information. The focus servo filter connects a switch 11 to any one of terminals t1, t2, t3. When the terminal t1 is selected, a servo loop is formed for feeding back the information to the focus actuator driver 4 via an AMP (amplifier circuit) 12, LPF (low-pass filter) 15 and HPF (high-pass filter) 16.

When the terminal t2 is selected, a servo loop is formed for feeding back the information to the focus actuator driver 4 via a notch filter A13, the LPF 15 and the HPF 15.

When the terminal t3 is selected, a servo loop is formed for feeding back the information to the focus actuator driver 4 via a notch filter B14, the LPF 15 and the HPF 15.

The servo operation of the embodiment is controlled as follows.

(1) After initialization of the disc (disc identification and various adjustments), or while the drive is performing a write/read operation or the like, a mean voltage measuring portion 17 of the focus servo filter 10 determines a mean value per revolution of the disc and inputs the mean value to a system control microcomputer 6.

(2) The measurement of the step (1) is periodically monitored during the normal operation and the control operation is switched between stages of the servo control characteristic.

(3) Threshold values A, B (0<A<B) are defined. The measured mean value V_{A} obtained in step (1) is compared with the threshold values and the following control is provided (see FIG. 3). When the value V_{A} is just intermediate between ±A and ±B, a control of the next stage may also be provided.

a) −A≦V_{A}≦A

The switch 11 is connected to t1 (no notch filter) and the gain of the AMP connected to the terminal t1 is set to normal.

b) −B≦V_{A}<−A

The switch 11 is connected to t2 to establish the servo loop via the notch filter A13.

c) V_{A}<−B

The switch 11 is connected to t3 to establish the servo loop via the notch filter B14.

d) A<V_{A}≦B

The switch 11 is connected to t1 (no notch filter) and the gain of the AMP connected to the terminal t1 is reduced.

e) B<V_{A}

The switch 11 is connected to t1 (no notch filter) and the gain of the AMP connected to the terminal t1 is further reduced.

As shown in FIG. 4, the notch filter B14 is defined to have a greater Q value than the notch filter A13.

It is known from experience that the notch filter provides asymmetrical responses to displacement of positive value and displacement of negative value in the focus direction because of influences of the magnetic characteristic of the pickup 5 and the mechanical characteristic thereof.

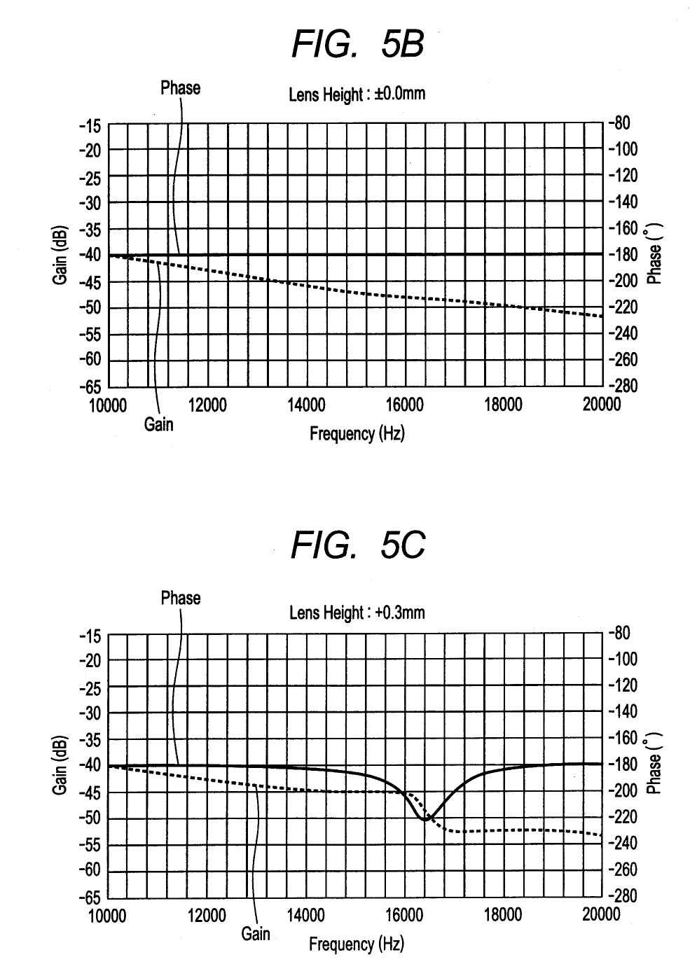

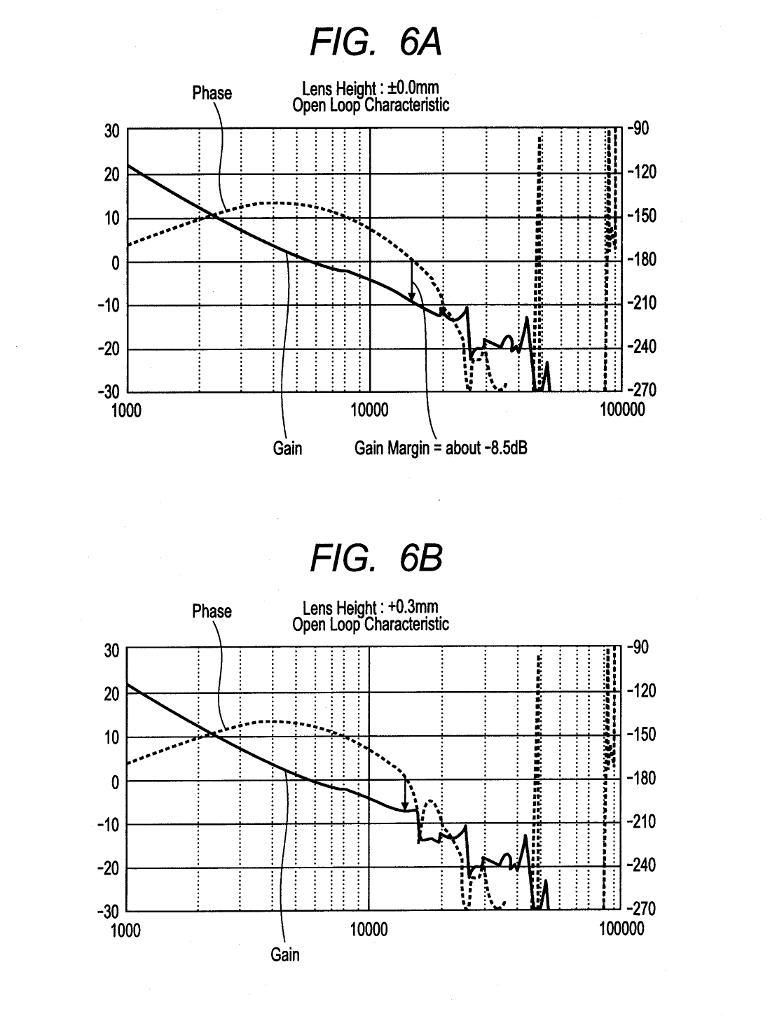

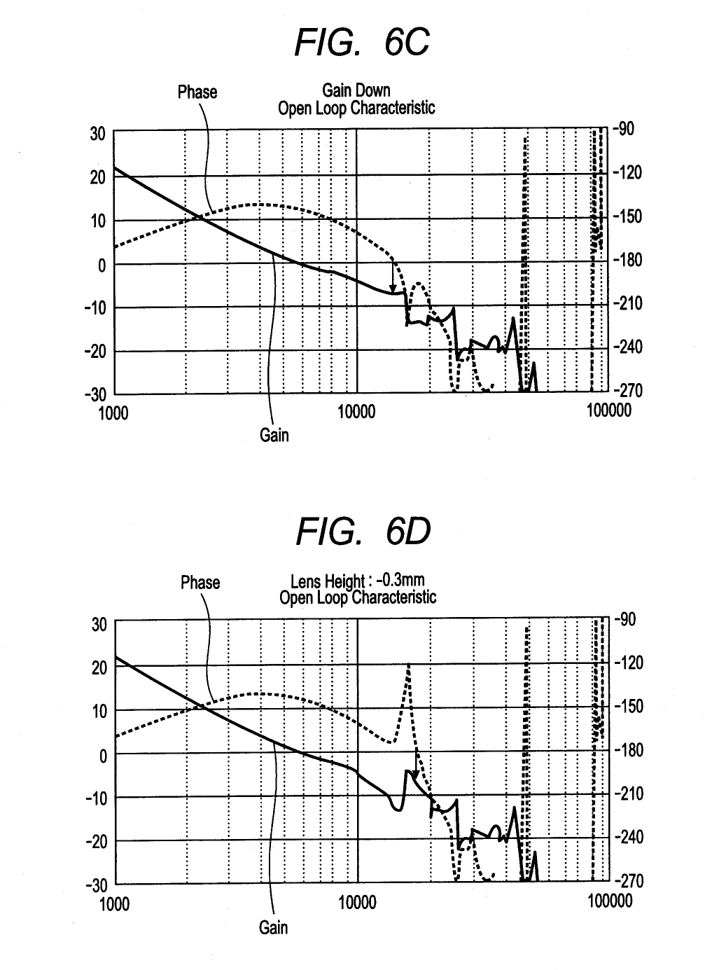

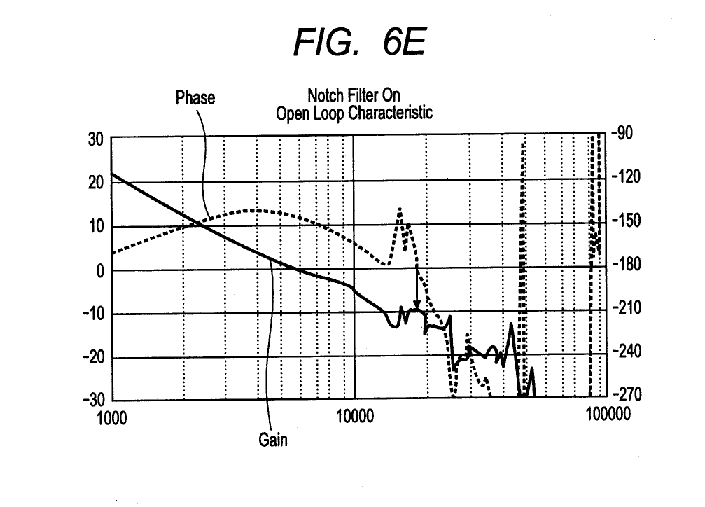

Next, servo characteristics provided by the embodiment will be described with reference to FIG. 5A to FIG. 6E.

FIG. 5A to FIG. 5C are Bode diagrams each plotting the resonance characteristic variations of the focus actuator displaced in the focus direction.

FIG. 6A to FIG. 6E are Bode diagrams each representing an open-loop frequency characteristic in a control stage.

Firstly, FIG. 5A illustrates a case where a lens height (displacement in the focus direction) is −0.3 mm.

This example corresponds to a stage (b) in FIG. 3. In this case, the switch 11 is connected to t2 to set the servo loop to the notch filter A.

As shown in FIG. 5A, the gain margin is decreased due to a gain peak caused by resonance appeared in the vicinity of 16.5 kHz and hence, the focus actuator involves the risk of oscillation. The gain margin indicates how much gain (above 0 dB) is provided when the phase is −180°. It is generally known that in a case where the gain at −180° phase has a value more than 0 dB, feedback control with input in opposite phase with output results in the application of positive feedback which causes the oscillation. In other words, the gain margin indicates how much margin is allowed before the gain at −180° phase decreases to 0 dB (the oscillation occurs).

In order to obviate the risk of oscillation induced by the decrease in the gain margin, it is necessary to operate the notch filter A13 to reduce the gain peak. In a case where the lens is displaced in a negative direction and the displacement is further increased, the peak of the gain varies according to the displacement quantity (the greater the displacement quantity, the higher the gain peak). According to the gain peak variation, the notch filter A13 is switched to the notch filter B14 (stage c in FIG. 3) so as to change the Q value of the filter.

FIG. 5B illustrates a case where the lens height (displacement in the focus direction) is ±0.0 mm.

This example corresponds to a stage (a) in FIG. 3. In this case, the switch 11 is connected to t1 and the AMP is set to a normal gain. In this case, the lens is at such a height that is hardly varied by resonance and hence, the need for the operation of the notch filter is negated. By switching off the notch filter in this manner, the servo margin can be increased compared to that when the notch filter is switched on.

Next, FIG. 5C illustrates a case where the lens height (displacement in the focus direction) is +0.3 mm.

This example corresponds to a stage (d) in FIG. 3. In this case, the switch 11 is connected to t1 (no notch filter). However the gain margin is decreased because of phase delay caused by resonance and a minor gain increase at a resonance point in comparison to the case where the gain is monotonically decreased. In order to obtain the same gain margin as that provided when the lens height is ±0.0 mm as shown in FIG. 5B, the gain of the AMP is reduced to force the overall gain down.

Next, a more detailed description is made on the relation between the frequency and the gain margin with reference to FIG. 6A to FIG. 6E.

It is noted here that in the Bode diagrams of FIG. 6A to FIG. 6E showing the open-loop frequency characteristics, the frequency is plotted on an x-axis logarithmic scale for enhancing the clarity of a frequency region where the gain margin is obtained.

FIG. 6A illustrates the case where the lens height (displacement in the focus direction) is ±0.0 mm (state shown in FIG. 5B). In this case, the gain margin is about −8.5 dB, which is considered to represent an ideal condition.

Setting the lens height to +0.3 mm provides the characteristic shown in FIG. 6B (the state shown in FIG. 5C). The gain margin in this case is decreased to about −7.0 dB due to the influence of resonance.

In this case, therefore, the gain of the AMP is reduced to force the overall gain down thereby maintaining the gain margin, as shown in FIG. 6C, equivalent to the ideal gain margin shown in FIG. 6A.

Setting the lens height to −0.3 mm provides the characteristic shown in FIG. 6D (the state shown in FIG. 5A). In this case, the gain peak induced by resonance coincides with a phase crossover frequency so that the gain margin is significantly decreased to about −4.0 dB.

In this case, therefore, the switch is connected to the notch filter so that the gain peak induced by resonance is eliminated as shown in FIG. 6E. In this manner, the gain margin can be maintained equivalent to the ideal gain margin shown in FIG. 6A.

As apparent from the above embodiment, the invention can provide the optical disc unit that can ensure stable operations by stabilizing the servo control of the actuators thereof without performing disturbance injection or measuring the disturbance.

What is claimed is:

1. An optical disc unit comprising: actuators for a pickup reproducing information written on an optical disc and recording information thereon; a focus servo filter; and a tracking servo filter, wherein frequency characteristics of the focus servo filter and the tracking servo filter are changed respectively according to a displacement quantity of the actuator in a focus direction and a displacement quantity of the actuator in a tracking direction.

2. The optical disc unit according to claim 1, wherein a mean output voltage or mean output current of the focus servo filter and a mean output voltage or mean output current of the tracking servo filter are measured respectively in order to determine the displacement quantity of the actuator in the focus direction and the displacement quantity of the actuator in the tracking direction.

3. The optical disc unit according to claim 1, wherein a notch filter is connected respectively to a servo loop of the focus servo filter and a servo loop of the tracking servo filter according to the displacement quantity of the actuator in the focus direction and the displacement quantity of the actuator in the tracking direction.

4. The optical disc unit according to claim 3, wherein the notch filters connected to the servo loops of the focus servo filter and the tracking servo filter are notch filters having Q values varied according to the displacement quantity of the actuator in the focus direction and the displacement quantity of the actuator in the tracking direction.

5. The optical disc unit according to claim 1, wherein respective gains of the servo loops of the focus servo filter and the tracking servo filter are varied according to the displacement quantity of the actuator in the focus direction and the displacement quantity of the actuator in the tracking direction.

6. An optical disc unit providing servo control of actuators for a pickup reproducing information written on an optical disc and recording information thereon, comprising:
means for measuring a mean output voltage of a focus servo filter and outputting a measurement value to a system control microcomputer; and
means for measuring a mean output voltage of a tracking servo filter and outputting a measurement value to the system control microcomputer,
wherein each of the focus servo filter and the tracking servo filter includes a switch following an instruction from the system control microcomputer and connecting to any one of an amplifier, a first notch filter and a second notch filter having a greater Q value than the first notch filter, the amplifier, the first notch filter and the second notch filter being components constituting respective servo loops.

7. A servo control method for actuator of a pickup reproducing information written on an optical disc and recording information thereon, comprising:
means for measuring a mean output voltage of a focus servo filter and outputting a measurement value to a system control microcomputer; and
means for measuring a mean output voltage of a tracking servo filter and outputting a measurement value to the system control microcomputer,
wherein each of the focus servo filter and the tracking servo filter includes a switch following an instruction from the system control microcomputer and connecting to any one of an amplifier, a first notch filter and a second notch filter having a greater Q value than the first notch filter, the amplifier, the first notch filter and the second notch filter being components constituting respective servo loops, and
wherein provided that V_{A} represents a measured mean output voltage of the focus servo filter or the tracking servo filter, and A and B represent threshold values of the mean output voltage (A<B),
in stage a) where −A≦V_{A}≦A,
the system control microcomputer connects the switch to the amplifier as the component constituting the servo loop and sets the gain of the amplifier to normal,
in stage b) where −B≦V_{A}<−A,
the system control microcomputer connects the switch to the first notch filter as the component constituting the servo loop,
in stage c) where V_{A}<−B,
the system control microcomputer connects the switch to the second notch filter as the component constituting the servo loop,
in stage d) where A<V_{A}≦B,
the system control microcomputer connects the switch to the amplifier as the component constituting the servo loop and reduces the gain of the amplifier from the normal gain in the stage a), and
in stage e) where B<V_{A},
the system control microcomputer connects the switch to the amplifier as the component constituting the servo loop and further reduces the gain of the amplifier from the gain in the stage d).
